(19) United States
(12) Patent Application Publication
(10) Pub. No.: US 2002/0103022 A1
(43) Pub. Date: Aug. 1, 2002

(54) Systems and methods for limiting a total amount won by a player based on the player's performance in a game of skill

(76) Inventors: Jessica Thompson Somol, Stamford, CT (US); Ian Jon Rehmert, Hoboken, NJ (US)

Correspondence Address: BUCKLEY, MASCHOFF, TALWALKAR, & ALLISON, 5 ELM STREET, NEW CANAAN, CT, 06840, US

(21) Appl. No.: 09/773,450

(22) Filed: Feb. 1, 2001

(51) Int. Cl. A63F 13/00

(52) U.S. Cl. 463/25

(57) ABSTRACT

Systems and methods are provided to limit an amount won by a player based on his or her performance in a game of skill. According to one embodiment, a net winning amount associated with the player is determined based on (i) an amount provided by the player in exchange for game play and (ii) an amount won by the player based on the player's performance in a game of skill. Based on the net winning amount, the player is prevented from winning at least one additional amount.

### FIELD

The present invention relates to game systems. In particular, the present invention relates to systems and methods for limiting a total amount won by a player based on his or her performance in a game of skill.

### BACKGROUND

Many people enjoying playing games of skill. For example, many people enjoy playing computer-based simulated golf games. In this case, a player provides one or more input parameters (e.g., a speed and angle associated with a swing of a simulated golf club), and a trajectory is calculated for a simulated golf ball based on the input parameters. A game result is then determined. For example, a successful game result may indicate that the simulated golf ball has come to rest within a predetermined distance of a simulated golf hole.

To increase a player's enjoyment, prizes may be awarded based on his or her performance in the game of skill. For example, a game provider may award $50 to any player who shoots a hole-in-one during a computer-based simulated golf game. To fund such a prize, a game provider may receive a payment from each player in exchange for game play (e.g., a payment of $1 in exchange for each swing of a simulated golf club).

Prizes can similarly be awarded in other types of games of skill. For example, a player may pay $1 in exchange for playing a trivia game, a word-puzzle game, or an arcade-style game (e.g., a game in which a player collects points as he or she maneuvers a character across a landscape or through a maze). The game provider may then award prizes based on game results (e.g., a player who scores 5,000 points in a trivia game may be awarded $5).

A number of problems may arise, however, when a game provider awards prizes based on game results. Consider, for example, a player who is, or becomes, an “expert” at a game of skill. Such an expert player may regularly be able to receive a prize by achieving a particular game result. If he or she continually plays the game, the game provider may need to award a large number of prizes (and provide payment of a significant total prize amount) to the expert player. In this case, the game provider may actually award a greater amount than it receives from players (e.g., especially if the prize amounts are large or if there are a large number of expert players). To avoid losing money, the game provider may attempt to increase the payments that players provide in exchange for game play. However, the non-expert players, who in effect would now be subsidizing the expert players, may stop playing the game. Instead of increasing payments received from players, the game provider may attempt to the reduce prize amounts that are provided to players. This, however, may make the game less enjoyable causing non-expert players to stop playing the game.

In addition the expert player problem, a game provider may find that some players use automated game playing devices to unfairly achieve game results and receive prizes. That is, a player may alter a game program or develop a supplemental program that unfairly provides an advantage during game play. For example, an automated game playing device may unfairly determine and display supplemental information to a player, such as a path through a maze that has been calculated by the automated playing device. Players who uses such automated game playing devices will cause many of the problems discussed above with respect to expert players (e.g., the game provider may lose money and/or players who do not use automated game playing devices may stop playing the game).

Instead of increasing payments received from players or reducing prize amounts, a game provider may attempt limit an overall amount that can awarded to a single player. Consider, for example, a game in which a players tries to solve five puzzles. Players who solve all five puzzles are awarded $25, players who solve four puzzles are awarded $5, and players who solve three or fewer puzzles receive no prize at all. In this case, the game provider may impose a total prize amount limit of $45 per week to reduce the problems caused puzzle experts and/or players who use automated game playing devices to solve puzzles.

Now consider, however, how a player would react to such a total prize amount limit if the player paid $2 each time he or she played the game. In this case, a player who has played the game twenty times will have provided a total of $40 in exchange for game play. If that player has solved all five puzzles in one game and four of the puzzles in five other games, he or she will have been awarded a total prize amount of $50 (i.e., $25+$5×5). Such a player will likely feel that the game provider is being unfair if he or she is not allowed to win further prize amounts. Moreover, the game provider may well be preventing game play by someone who is not a puzzle expert and is not using an automated game playing device to solve the puzzles.

Problems may also arise if the total prize amount that can be awarded to a player is limited for predetermined period of time (e.g., by limiting the total prize amount to $50 per week). For example, an expert player may simply wait for the predetermined period of time to pass and then resume playing the game (and receive further prizes).

Further, there may be other disadvantages with limiting the total prize amount that a game provider will award to a player. For example, a player who is an expert at a particular trivia game may be unnecessarily prevented from receiving further prizes with respect to other trivia games, or types of games, associated with the game provider (e.g., including an arcade-style game).

### SUMMARY

To alleviate problems inherent in the prior art, the present invention introduces systems and methods for limiting a total amount won by a player based on his or her performance in a game of skill.

According to one embodiment of the present invention, a player provides payment in exchange for playing a game of skill. The player is then prevented from winning more than a threshold amount based on his or her performance in the game of skill.

According to another embodiment, a net winning amount associated with a player is determined based on (i) an amount provided by the player in exchange for game play and (ii) an amount won by the player based on his or her performance in a game of skill. Based on the net winning amount, the player is prevented from winning at least one additional amount.

Another embodiment is directed to a computer-implemented method of limiting an amount won by a player based on his or her performance in at least one a game of skill played via a communication network. A remote player device may, for example, communicate with a game controller through the communication network to facilitate game play. It is arranged to receive from the player payment of an amount in exchange for game play during a game period. An amount won by the player during the game period is determined based on the his or her performance in at least one game of skill. It is then arranged to provide to the player payment of the amount won by the player. A net winning amount associated with the player is determined based on (i) the amount provided by the player and (ii) the amount won by the player. A threshold winning amount is also determined, and, based on the net winning amount and the threshold winning amount, the player is prevented from winning at least one additional amount.

According to still another embodiment of the present invention, a winning amount associated with a player is determined. Based on the winning amount, the player is prevented from winning at least one additional amount for an indefinite period.

According to yet another embodiment, a winning amount associated with the player is determined. A winning limit rule is also determined, and, based on the winning amount and the winning limit rule, the player is prevented from winning at least one additional amount.

Another embodiment of the present invention is directed to a method of limiting an amount provided by a player. In this case, a net provided amount associated with the player is determined based on (i) an amount provided by the player in exchange for game play and (ii) an amount won by the player based on his or her performance in a game of skill. Based on the net provided amount, the player is prevented from providing at least one additional amount.

According to another embodiment, an amount provided by a player is determined. Based on the amount provided by the player, the player is prevented from providing at least one additional amount for an indefinite period.

According to another embodiment, an amount provided by a player is determined. A providing limit rule is also determined, and, based on the amount provided and the providing limit rule, the player is prevented from providing at least one additional amount.

One embodiment of the present invention comprises: means for determining a net winning amount associated with the player based on (i) an amount provided by the player in exchange for game play and (ii) an amount won by the player based on his or her performance in a game of skill; and means for preventing the player from winning at least one additional amount based on the net winning amount.

Another embodiment of the present invention comprises: means for arranging to receive from a player payment of an amount in exchange for game play during a game period; means for determining an amount won by the player during the game period based on his or her performance in at least one game of skill; means for arranging to provide to the player payment of the amount won by the player; means for determining a net winning amount associated with the player based on (i) the amount provided by the player and (ii) the amount won by the player; means for determining a threshold winning amount; and means for preventing the player from winning at least one additional amount based on the net winning amount and the threshold winning amount.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of a game system according to an embodiment of the present invention.

FIG. 2 is a flow chart of a method for facilitating game play according to an embodiment of the present invention.

FIG. 3 is a block diagram of a game controller according to an embodiment of the present invention.

FIG. 4 is a block diagram of a game controller according to an embodiment of the present invention.

FIG. 5 is a tabular representation of a portion of a player database according to an embodiment of the present invention.

FIG. 6 is a tabular representation of a player-winnings database according to an embodiment of the present invention.

FIG. 7 is a tabular representation of a winning limit rule database according to an embodiment of the present invention.

FIG. 8 is a flow chart of a method according to an embodiment of the present invention.

FIG. 9 is a flow chart of a method according to another embodiment of the present invention.

FIGS. 10A through 10C illustrate player devices displaying winning limit information according to some embodiments of the present invention.

### DETAILED DESCRIPTION

Embodiments of the present invention are directed to systems for limiting a total “amount” won by a player based on his or her performance in a game of skill. As used herein, the term “amount” refers to any right associated with a player. An amount may represent, for example, a payment that has been, or will be, provided to a player. An amount may also represent some other benefit, such as an alternate currency amount (e.g., a gift certificate amount), that is associated with a player.

Game System Overview

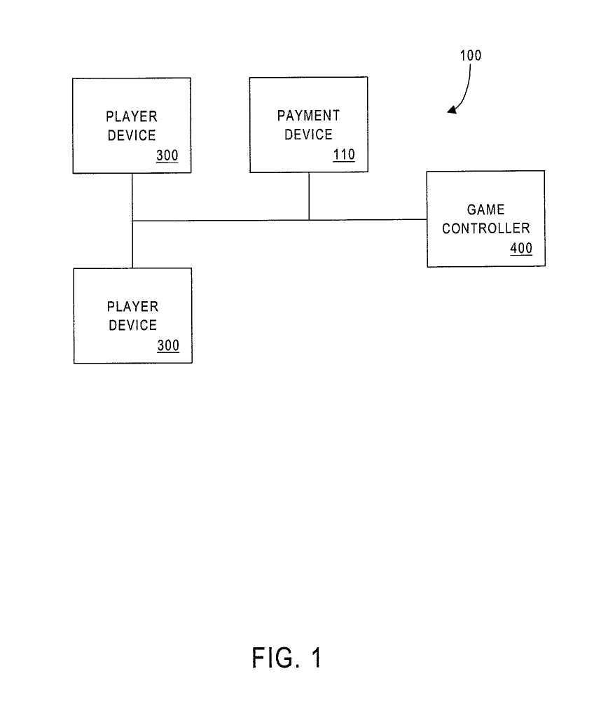

Turning now in detail to the drawings, FIG. 1 is a block diagram of a game system 100 according to one embodiment of the present invention. The game system 100 includes a game controller 400 in communication with a number of player devices 300. As used herein, devices (such as the player devices 300 and the game controller 400) may communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Moreover, as used herein, communications include those enabled by wired or wireless technology. Note that although a single game controller 400 is shown in FIG. 1, any number of game controllers 400 may be included in the game system 100. Similarly, any number of the other devices described herein may be included in the game system 100 according to embodiments of the present invention.

In one embodiment of the present invention, a player device 300 communicates with a remote, Web-based game controller 400 (e.g., a server) via the Internet. Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

The player device 300 and the game controller 400 may be any devices capable of performing the various functions described herein. The player device 300 may be, for example: a Personal Computer (PC), a portable computing device such as a Personal Digital Assistant (PDA), a wired or wireless telephone, a one-way or two-way pager, a kiosk (e.g., a game kiosk located at an airport terminal), an interactive television device, a game terminal (e.g., a SONY PLAY STATION® video game terminal), or any other appropriate storage and/or communication device.

Note that the devices shown in FIG. 1 need not be in constant communication. For example, a player device 300 may only communicate with the game controller 400 via the Internet when appropriate (e.g., when attached to a “docking” station or “cradle” coupled to a player's PC). Note also that a player device 300 and the game controller 400 may be incorporated in a single device (e.g., a game kiosk may act as both a player device 300 and the game controller 400).

According to an embodiment of the present invention, a player uses a player device 300 to communicate with the game controller 400. For example, a player may use his or her PC to access a Web site associated with the game controller 400. The player may then play a game of skill (e.g., a computer-based golf game associated with a physics simulation), such as by using a keyboard or mouse coupled to the PC to provide input parameters to the game controller 400.

According to one embodiment, the game controller 400 also arranges for the player to provide a payment in exchange for game play and/or arranges for the player to receive a payment of one or more prize amounts. For example, the game controller 400 may arrange for $1,000 to be paid to a player who correctly answers twenty trivia questions. According to such an embodiment, a payment device 110 may be used to arrange for the player to provide and/or receive payments. For example, the game controller 400 may arrange for a player to purchase one or more game plays via the payment device 110 (e.g., via a credit card account, a debit card account, a banking account, or an electronic payment protocol). The payment device 110 may comprise, for example, a third party device (e.g., a credit card processing device), a check printer, and/or or an Automated Clearing House (ACH) device (e.g., when arranging to provide a “direct deposit” payment via a player's bank account).

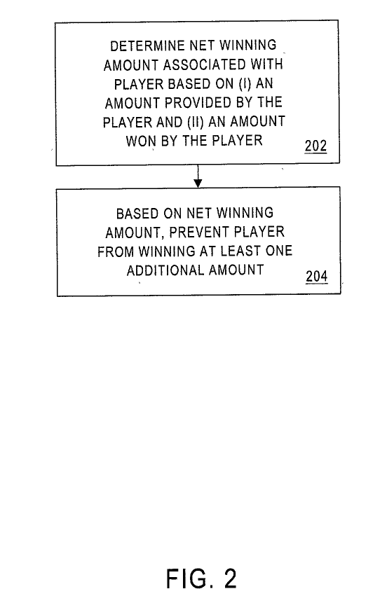

FIG. 2 is a flow chart of a method for facilitating games played via the game system 100 according to an embodiment of the present invention. The method shown in FIG. 2 may be performed, for example, by the game controller 400 and/or a player device 300. At 202, a net winning amount associated with a player is determined based on (i) an amount provided by the player and (ii) an amount won by the player. For example, the amount won by the player may be reduced by the amount provided by the player to calculate a net winning amount. A net winning amount may be “associated” with a player by being associated with, for example, a player identifier, a player device, and/or a payment identifier.

The amount “provided” by the player may comprise, for example, an amount paid by the player in exchange for playing one or more games of skill. According to one embodiment, the game controller 400 arranges via a payment identifier to receive payment of this amount from the player. The payment identifier may be associated with, for example, a credit card account, a debit card account, a bank account, or a digital payment protocol. The game controller 400 may determine the amount provided by the player by, for example, retrieving a value stored in a database.

Note that, as used herein, the phrase “game of skill” refers to any game having a game result that is determined predominately by a player's skill. Examples of games of skill include trivia games, games associated with a physics simulation (e.g., a computer-based golf game), puzzle games, and arcade-style games.

The amount “won” by the player may comprise, for example, an amount won by the player based on the player's performance in one or more games of skill. According to one embodiment, the game controller 400 arranges via a payment identifier (e.g., a credit card number, a debit card number, a back account number, or digital payment protocol information) to provide payment of this amount to the player. Note that the amount won by the player may comprise a single amount or a plurality of amounts won by the player (in one or more games of skill). For example, the game controller 400 may determine a game result based on the player's performance in a game of skill (e.g., by determining a player's “score” in a game). The game controller 400 may then calculate an amount to be provided to the player based on the game result. In this case, the amount won by the player may be based on a single game result or a plurality of game results (in one or more games of skill). The game controller 400 may also determine the amount won by the player by, for example, retrieving a value stored in a database.

The net winning amount may be associated with a game “period,” such as a period of time. For example, the net winning amount may be associated with the last seven days. In this case, the amount won by the player during those seven days may be reduced by the amount provided by the player during that period to calculate a net winning amount. Other types of game periods include, for example, a duration of game play (e.g., the last three hours of game play), a number of game plays (e.g., the last fifty games), and a number of game results. Note that an amount provided by the player may also acts as a game period. For example, the game controller 400 may evaluate the amount won by the player during his or her last $50 worth of game play to determine if the player will be prevented from winning an additional amount. According to another embodiment, the net winning amount is not associated with a game period. That is, the game controller 400 may simply track the “lifetime” amounts provided by the player and/or won by the player.

Note that different game periods may be associated with, for example, the amount provided by the player and the amount won by the player. For example, the amount won by the player during the last seven days may be reduced by the amount provided by the player during the last thirty days to determine a net winning amount.

At 204, the player is prevented from winning at least one additional amount based on the net winning amount. For example, the net winning amount may be evaluated based on one or more threshold amounts to determine if the player will be prevented from winning an additional amount. As an example, the game controller 400 may determine if a player's net winning amount for the last two days is more than $200. The game controller 400 may also determine if that player's net winning amount for the last thirty days is more than $1,000. If either of the two threshold amounts are exceeded, the game controller 400 may prevent that player from winning any additional amounts (e.g., for a period of time).

Note that a player may be allowed to win a total amount that is greater than a threshold amount before he or she is prevented from winning an additional amount. Consider, for example, a game provider who establishes a $500 per week threshold amount and a player who has, thus far, won $450 in a particular week. According to one embodiment, the player would still be allowed to win another $200 prize (e.g., because he or she was below the $500 threshold amount prior to winning the prize), even though the player will win a total of $650 in that week. According to another embodiment, the $200 prize is automatically reduced to $50 (i.e., resulting in a total winning amount equal to the threshold amount).

A game controller 400 may “prevent” a player from winning an additional amount, for example, by preventing the player from playing one or more games of skill. For example, after a player has won $500 in a single month, he or she may be prevented from playing games via the game controller 400 until the next month.

According to another embodiment, a player is able to play a number of different games via the game controller 400. For example, the player may be able to play both a trivia game and a word-puzzle game via the game controller 400. In this case, a player may be, for example, prevented from playing any games (i.e., both the trivia game and the word-puzzle game) or may only be prevented from playing specific games (e.g., a player may be prevented from playing the trivia game if he or she has won more than $1,000 playing the trivia game).

According to another embodiment, different games of skill are associated with different game “categories.” For example, a player may be able to play ten different arcade-style games and five different trivia games via the game controller 400. In this case, a player may be prevented from playing games of skill associated with a particular game category. That is, a player who has won more than $250 during his or her last five hours of arcade-style game play may be prevented from playing any of the ten arcade-style games (i.e., while still being allowed to play any of the five trivia games).

According to another embodiment, the player is still allowed to play the games, but is told that he or she will not receive payment of any additional amounts even if he or she achieves a successful game result.

Note that the game controller 400 may prevent the player from being able to win a first additional amount while allowing the player to win a second additional amount. For example, a player may be allowed to win a $10 prize amount but be prevented from winning a $100 prize amount.

A player may be prevented from winning an additional amount for a predetermined period. For example, a player may be prevented from winning an additional amount for thirty days. A player may instead be prevented from winning an additional amount, for example, for a predetermined duration of game play (e.g., for the next hour of game play), number of game plays (e.g., the next twenty games), or number of game results. The predetermined period may be based on, for example, the net winning amount, the amount provided by the player, the amount won by the player, a game result, information associated with a game, and/or information associated with the player (e.g., a recently registered player may be prevented from winning additional amounts for a longer predetermined period of time).

A player may be prevented from winning an additional amount for an indefinite period. For example, a player may be prevented from winning any additional amounts forever. Similarly, a player may be prevented from winning any additional amounts pending certification of a game result. For example, a player who has won a $1,000 prize amount may be prevented from winning any further $1,000 prize amounts until his or her game results are validated by the game controller 400.

According to another embodiment, the game controller 400 determines a winning limit rule. A player may then be prevented from winning an additional amount based on the winning limit rule. The winning limit rule may be associated with, for example, the net winning amount, the amount provided by the player, the amount won by the player, a game result (e.g., a game score), information associated with a game (e.g., a game category), and/or information associated with the player (e.g., past game results associated with that player).

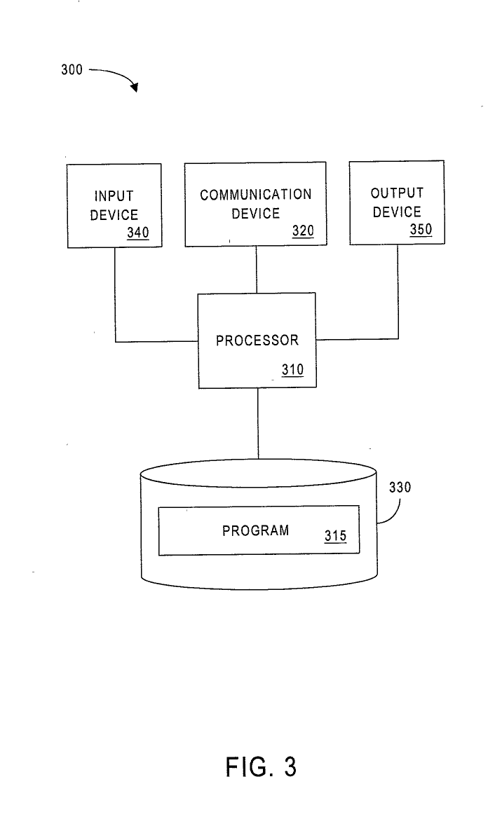

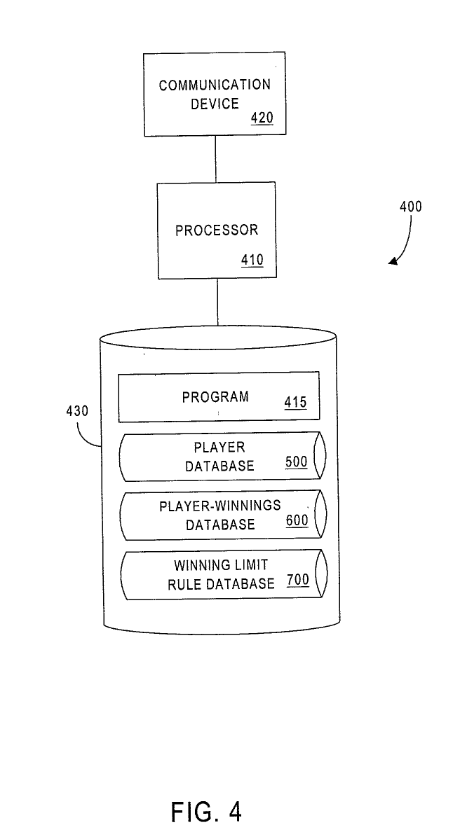

Examples of some of the devices that may be used in connection with the game system 100 will now be described in detail with respect to FIGS. 3 and 4.

Player Device

FIG. 3 illustrates a player device 300 that is descriptive of the device shown in FIG. 1 according to an embodiment of the present invention. The player device 300 comprises a processor 310, such as one or more INTEL® Pentium® processors, coupled to a communication device 320 configured to communicate via a communication network (not shown in FIG. 3). The communication device 320 may be used to communicate, for example, with the game controller 400 and/or the payment device 110.

The processor 310 is also in communication with an input device 340. The input device 340 may comprise, for example, a keyboard, a mouse or other pointing device, a microphone, a knob or a switch (including an electronic representation of a knob or a switch), an infrared port, a docking station, and/or a touch screen. Such an input device 340 may be used, for example, by a player to play a game (e.g., by manipulating a pointer associated with a computer-based golf game).

The processor 310 is also in communication with an output device 350. The output device 340 may comprise, for example, a display (e.g., a computer monitor), a speaker, and/or a printer. The output device 350 may be used, for example, to provide game and winning limit information to a player.

The processor 310 is also in communication with a storage device 330. The storage device 330 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 330 stores a program 315 for controlling the processor 310. The processor 310 performs instructions of the program 315, and thereby operates in accordance with the present invention. For example, the processor 310 may arrange for a player to play a game of skill and/or for winning limit information to be displayed to the player.

As used herein, information may be “received” by or “transmitted” to, for example: (i) the player device 300 from the game controller 400; or (ii) a software application or module within the player device 300 from another software application, module, or any other source.

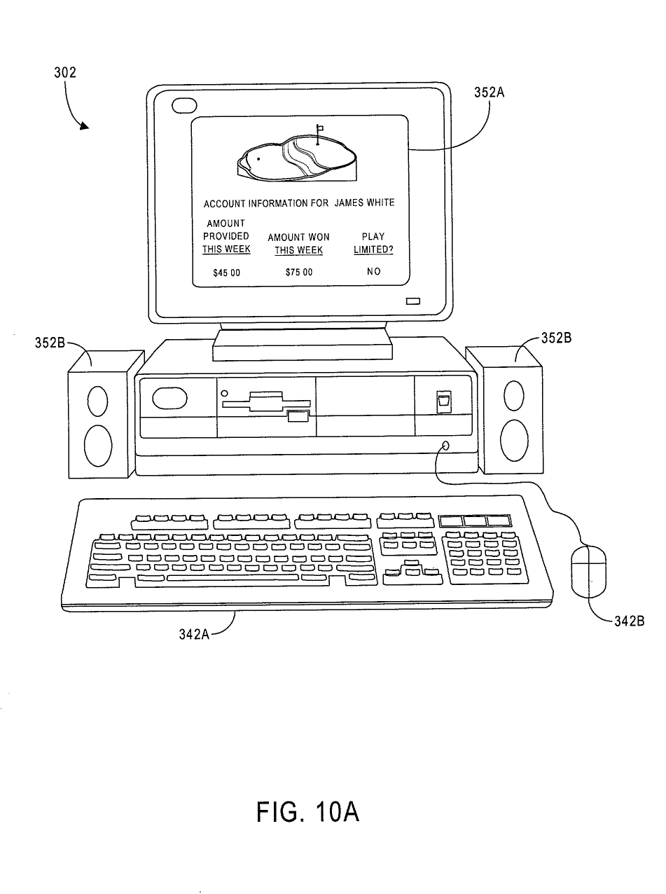

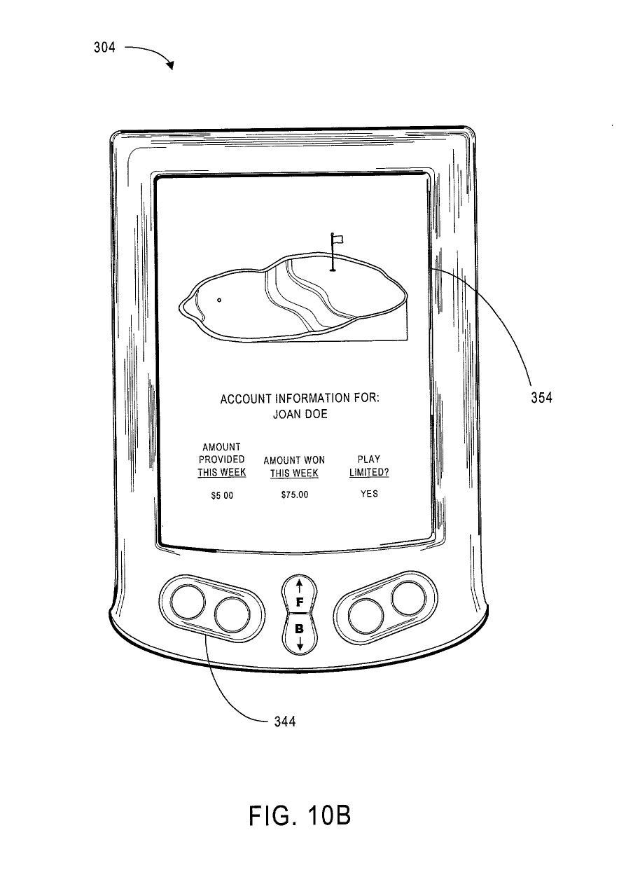

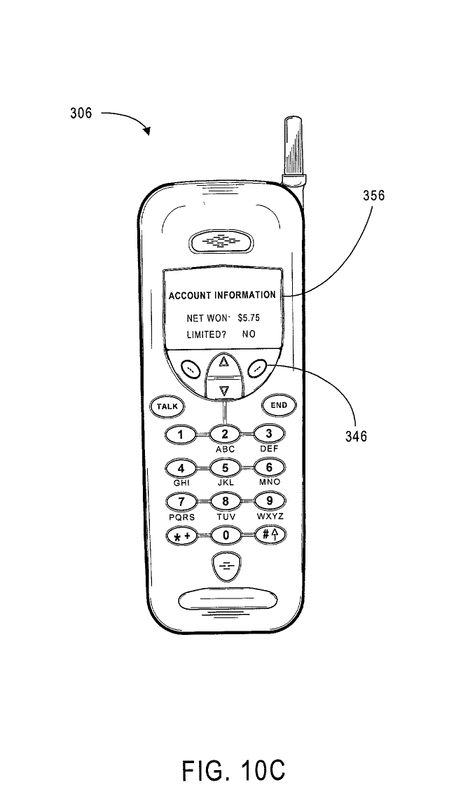

FIG. 10A illustrates a PC 302 displaying winning limit information according to an embodiment of the present invention. The PC 302 includes a keyboard 342A and a mouse 342B which can be used by a player to play a game of skill. The PC 302 also includes a computer display 352A and speakers 352B which can be used, for example, to provide account information to a player.

As shown in FIG. 10A, the account information may include an indication of whether or not play by that player is currently “limited” (e.g., whether or not the player will be prevented from playing games of skill because of a net winning amount). Other information that may be displayed includes, for example, a net winning amount, a total amount provided by the player, a total amount won by the player, an amount provided by the player during a game period, an amount won by the player during a game period, a period of time during which the player will be prevented from winning at least one additional amount, and one or more additional amounts the player will be prevented from winning.

FIG. 10B illustrates a PDA 304 displaying winning limit information according to another embodiment of the present invention. The PDA 304 includes an input device 344 and an output device 354 (e.g., a display screen) that may be used by a player to play a game. Similarly, FIG. 10C illustrates a wireless telephone 306 including an input device 346 and an output device 356 displaying winning limit information.

Game Controller

FIG. 4 illustrates a game controller 400 that is descriptive of the device shown in FIG. 1 according to an embodiment of the present invention. The game controller 400 comprises a processor 410, such as one or more INTEL® Pentium® processors, coupled to a communication device 420 configured to communicate via a communication network (not shown in FIG. 4). The communication device 420 may be used to communicate, for example, with one or more player devices 300 and/or the payment device 110.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as RAM devices and ROM devices.

The storage device 430 stores a program 415 for controlling the processor 410. The processor 410 performs instructions of the program 415, and thereby operates in accordance with the present invention. For example, the processor 410 may determine a net winning amount associated with the player based on (i) an amount provided by the player in exchange for game play and (ii) an amount won by the player based on his or her performance in a game of skill. The processor 410 may also prevent the player from winning at least one additional amount based on the net winning amount.

According to another embodiment, the processor 410 arranges (e.g., via a payment identifier) to receive payment from a player of an amount in exchange for game play during a game period. The processor 410 also determines an amount won by the player during the game period based on his or her performance in at least one game of skill, and arranges to provide to the player payment of the amount won by the player. A net winning amount associated with the player is then calculated by the processor 410 based on (i) the amount provided by the player and (ii) the amount won by the player. A threshold winning amount, and, based on the net winning amount and the threshold winning amount, the processor 410 prevents the player from winning at least one additional amount (e.g., by preventing the player from playing at least one game of skill).

The program 415 may be stored in a compressed, uncompiled and/or encrypted format. The program 415 may furthermore include other program elements, such as an operating system, a database management system, and/or device drivers used by the processor 410 to interface with peripheral devices.

As used herein, information may be “received” by or “transmitted” to, for example: (i) the game controller 400 from the player device 300; or (ii) a software application or module within the game controller 400 from another software application, module, or any other source.

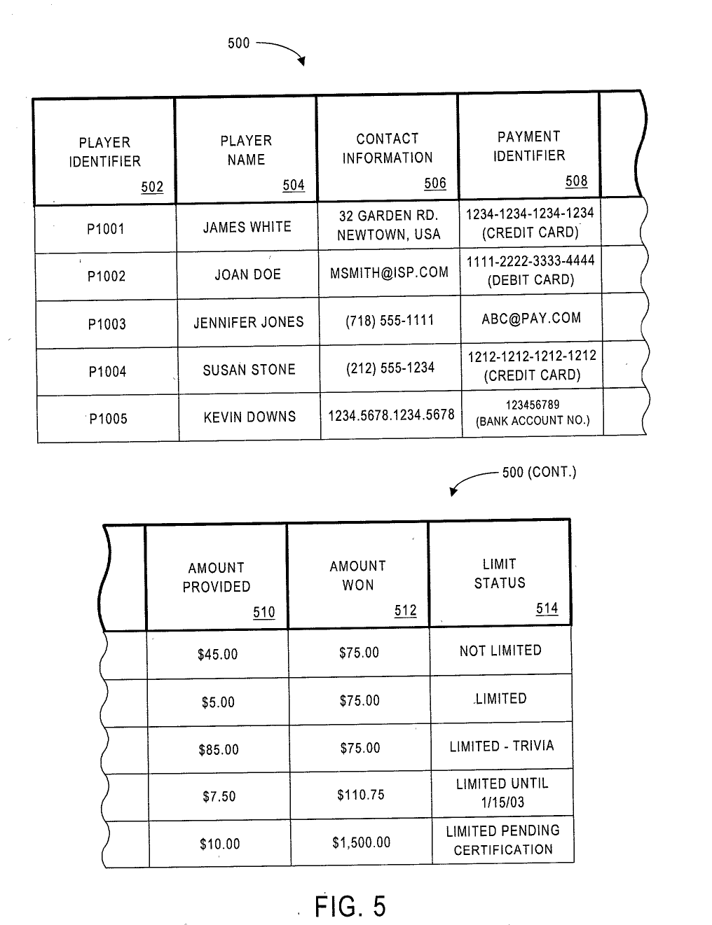

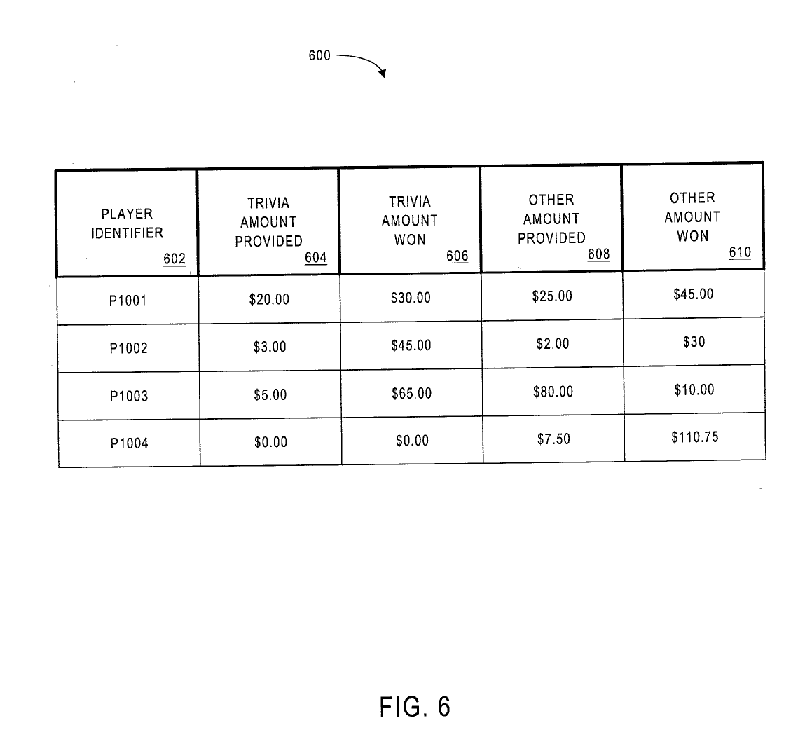

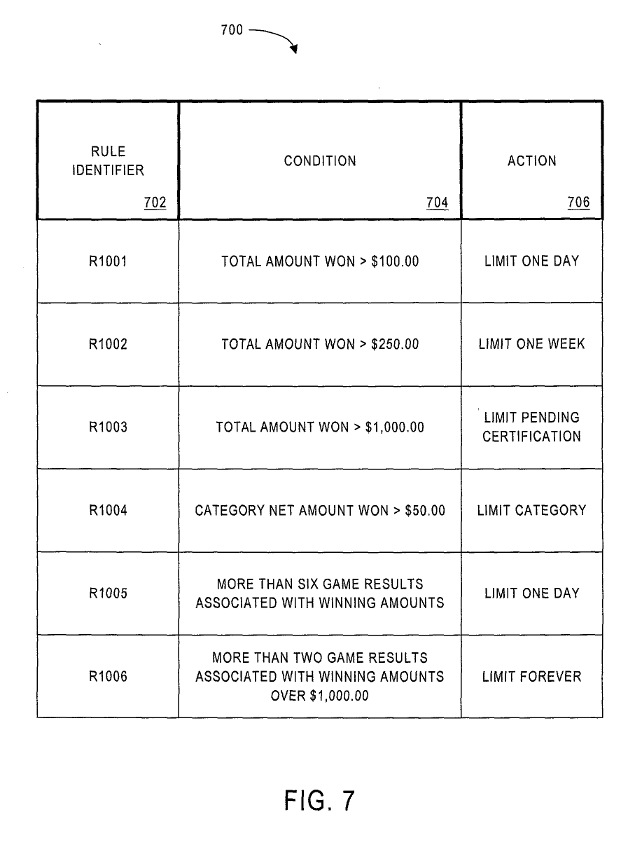

As shown in FIG. 4, the storage device 430 also stores a player database 500 (described with respect to FIG. 5), a player-winnings database 600 (described with respect to FIG. 6), and a winning limit rule database 700 (described with respect to FIG. 7). Examples of databases that may be used in connection with the game system 100 will now be described in detail with respect to FIGS. 5 through 7. The illustrations and accompanying descriptions of the databases presented herein are exemplary, and any number of other database arrangements could be employed besides those suggested by the figures.

Player Database

Referring to FIG. 5, a table represents the player database 500 that may be stored at the game controller 400 according to an embodiment of the present invention. The table includes entries identifying players who may play games via the game system 100. The table also defines fields 502, 504, 506, 508, 510, 512, 514 for each of the entries. The fields specify: a player identifier 502, a name 504, contact information 506, a payment identifier 508, an amount provided 510, an amount won 512, and a limit status 514. The information in the player database 500 may be created and updated, for example, based on information received from player when he or she registers with the game controller 400. The information in the player database 500 may also be based on, for example, information generated as players play games of skill via the game system 100.

The player identifier 502 may be, for example, an alphanumeric code associated with a player who has registered to use the game system 100. The player identifier 502 may be generated by, for example, the game controller 400 or the player (e.g., when the player provides a user name and password). According to one embodiment, the player identifier 502 is also stored on a remote player device 300 (e.g., as part of a browser “cookie” file). The player database 500 also stores the name 504 and contact information 506 (e.g., a postal address, an electronic mail address, an IP address, or a telephone number) associated with each player.

The payment identifier 508 may comprise, for example, a credit card, debit card or bank account number (e.g., a checking account number) or digital payment protocol information. The payment identifier 508 may be used, for example, by the game controller 400 to arrange for the player to provide or receive a payment.

The amount provided 510 represents an amount that has been provided by the player (e.g. via his or her credit card account) in exchange for game play. The amount won 512 represents an amount that has been, or will be, provided to the player based on his or her performance in at least one game of skill (e.g., a total amount that has been won by the player).

The limit status 514 indicates if the player will be prevented from winning at least one additional amount. According to an embodiment of the present invention, the limit status 514 is determined by the game controller 400 based on the amount provided 510 and the amount won 512. For example, if the amount won 512 reduced by the amount provided 510 is not more than a threshold amount, the limit status 514 may indicate that the player is “not limited” from winning additional amounts. If the amount won 512 reduced by the amount provided 510 is more than a threshold amount, the limit status 514 may indicate that the player is “limited” from winning one or more additional amounts.

According to some embodiments of the present invention, the limit status 514 may indicate that the player is limited from winning particular amounts (e.g., amounts over $100), amounts in a particular game or game category (e.g., amounts in trivia games), amounts during a definite period (e.g., until a particular date), or amounts during an indefinite period (e.g., until a game result is certified).

Consider now a game provider who decides that players will not be allowed to achieve a net winning amount of more than $50 (e.g., in a single day). The first entry in the player database 500 (e.g., associated with “James White”) indicates that his amount won 512 reduced by his amount provided 510 equals $30 (i.e., $75-$45). Because this is less than the $50 threshold amount, his limit status 514 indicates that he will not be prevented from winning additional amounts (e.g., is “not limited”).

The second entry in the player database 500 (e.g., associated with “Joan Doe”) indicates that her amount won 512 reduced by her amount provided 510 equals $70 (i.e., $75-$5). Because this is more than the $50 threshold amount, her limit status 514 indicates that she will be prevented from winning additional amounts (e.g., is “limited”).

However, the third entry in the player database 500 (e.g., associated with “Jennifer Jones”) indicates that her amount won 512 reduced by her amount provided 510 equals less than the $50 threshold amount. Nevertheless, her limit status 514 indicates that she will be prevented from winning additional amounts in trivia games (e.g., is “limited—trivia”). This situation will be explained in further detail with respect to the player-winnings database 600.

Player-Winnings Database

Referring to FIG. 6, a table represents the player-winnings database 600 that may be stored at the game controller 400 according to an embodiment of the present invention. The table includes entries identifying in detail the amounts that have been provided and/or won by a player via the game system 100. The table also defines fields 602, 604, 606, 608, 610 for each of the entries. The fields specify: a player identifier 602, a trivia amount provided 604, a trivia amount won 606, an other amount provided 608, and an other amount won 610. The information in the player-winnings database 600 may be updated, for example, based on information generated as players play games of skill via the game system 100.

The player identifier 602 may be, for example, an alphanumeric code and may be based on, or associated with, the player identifier 502 stored in the player database 500.

The trivia amount provided 604 may represent an amount that has been provided by the player (e.g. via his or her credit card account) in exchange for playing at least one trivia game. The trivia amount won 606 may represent an amount that has been, or will be, provided to the player based on his or her performance in trivia games (e.g., a total amount that has been won by the player in trivia games). Note that a game provider may offer several different types of games that are associated with a “trivia” category. In this case, the trivia amount provided 604 and the trivia amount won 606 may reflect amounts that are associated with all of those trivia games.

The other amount provided 608 may represent an amount that has been provided by the player in exchange for playing at least one non-trivia game (e.g., including puzzle games and arcade-style games). The other amount won 610 may represent an amount that has been, or will be, provided to the player based on his or her performance in non-trivia games.

Note that the amount provided 510 stored in the player database 500 may represent the sum of the trivia amount provided 604 and the other amount provided 608. Similarly, the amount won 512 stored in the player database 500 may represent the sum of the trivia amount won 606 and the other amount won 610.

Consider again the third entry in the player database 500 (e.g., associated with “Jennifer Jones” having a player identifier 502 of “P1003”). Recall that her amount won 512 reduced by her amount provided 510 equals less than the $50 threshold amount, yet her limit status 514 indicates she will be prevented from winning additional amounts in trivia games. This is because her trivia amount won 606 reduced by her trivia amount provided 604 equals $60 (i e., $65-$5), which is more than the $50 threshold amount. Note that her other amount won 610 reduced by her other amount provided 608 equals less than the $50 threshold amount—and thus she will not be prevented from winning additional amounts in non-trivia games. According to one embodiment, the game controller 400 establishes different threshold amounts with respect to a player's overall net winning amount and per-category net winning amounts.

In addition to the information stored in the player database 500 and the player-winnings database 600, the game controller 400 may also store, for example a free-play amount representing complimentary game play to be provided to the player (e.g., complimentary game play won by the player during game play or otherwise awarded to the player). The free-play amount may or may not be considered by the game controller 400 when determining a net winning amount.

Note that the amounts described herein do not necessarily need to represent monetary amounts. For example, some amounts may be expressed as an amount of game play (e.g., a player may have “twenty free games” or “ten minutes of free game play”).

Winning Limit Rule Database

Referring to FIG. 7, a table represents the winning limit rule database 700 that may be stored at the game controller 400 according to an embodiment of the present invention. The table includes entries identifying rules that may be used by the game controller 400 to determine, for example, if a player will be prevent from winning additional amount via the game system 100. The table also defines fields 702, 704, 706 for each of the entries. The fields specify: a rule identifier 702, a condition 704, and an action 706. The information in the winning limit rule database 700 may be created and updated, for example, by a game provider associated with the game controller 400.

The rule identifier 702 may be, for example, an alphanumeric code associated with a winning limit rule. The condition 704 indicates one or more conditions that may be evaluated by the game controller 400. The action 706 indicates one or more acts or steps that may be performed by the game controller 400 when an associated condition 704 is satisfied.

For example, as illustrated by the first two entries shown in FIG. 7 (i.e., having rule identifiers 702 of “R1001” and “R1002”), a game controller 400 may evaluate an amount won by a player (e.g., with or without considering an amount provided by the player) to determine if the amount won is more than either of two predetermined threshold amounts (i.e., “$100” and “$250”). Based on the evaluation, the player may be prevented from winning additional amounts for a predetermined period (i.e., “one day” or “one week”). Similarly, as illustrated by the third and sixth entries shown in FIG. 7 (i.e., having rule identifiers 702 of “R1003” and “R1006”), a player may be prevented from winning additional amounts for an indefinite period (e.g., “pending certification” or “forever”).

As another example, consider the fifth and sixth entries shown in FIG. 7 (i.e., having rule identifier 702 of “R1005” and “R006”). These winning limit rules are based on game results achieved by a player as opposed to a total amount won by the player.

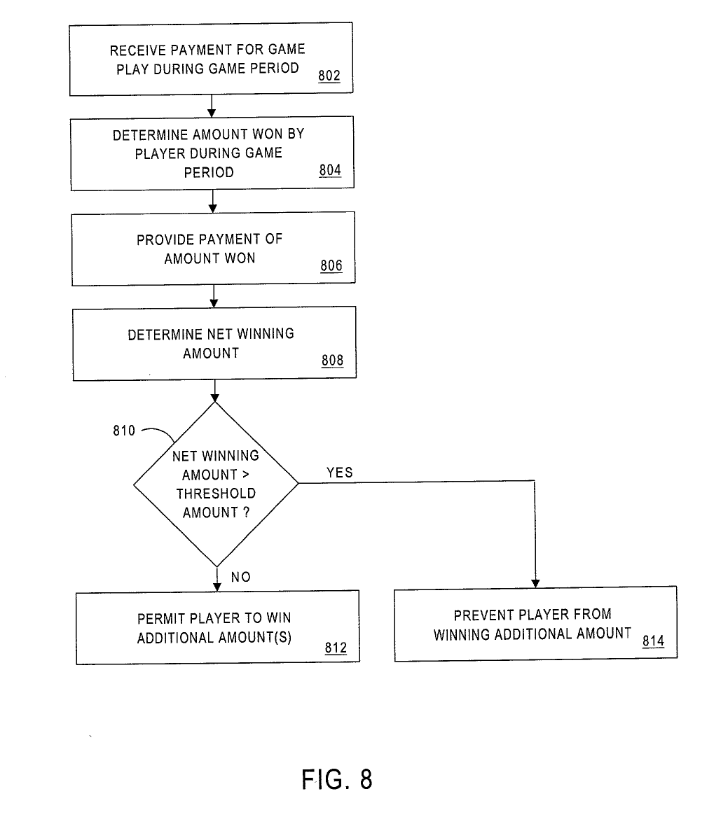

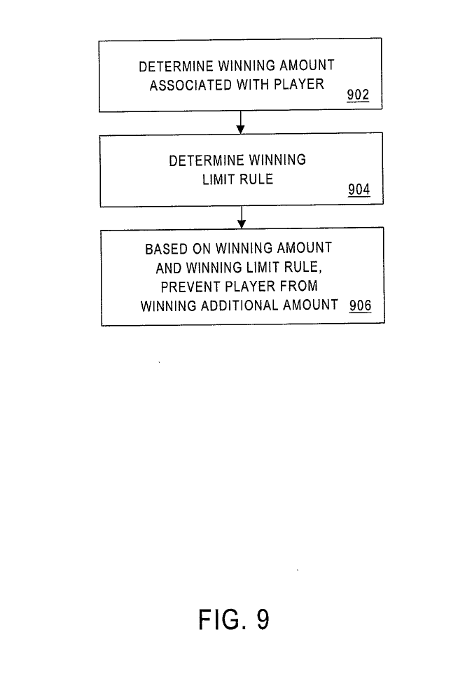

Methods that may be used in connection with the game system 100 according to some embodiments of the present invention will now be described in detail with respect to FIGS. 8 and 9.

Game System Methods

FIG. 8 is a flow chart of a computer-implemented method of limiting an amount won by a player. The method may be performed, for example, by a game controller 400 that communicates with a remote player device 300 through a communication network. The flow charts in FIG. 8 and the other figures described herein do not imply a fixed order to the steps, and embodiments of the present invention can be practiced in any order that is practicable. Moreover, the methods may instead be performed by any of the other devices described herein, including a player device 300.

At 802, the game controller 400 arranges to receive from the player payment of an amount in exchange for game play during a game period. For example, the game controller 400 may use the player's credit card number to arrange for the player to provide $40 during a particular week. The game controller 400 may also update the amount provided 510 stored in the player database 500 along with, according to one embodiment, the trivia amount provided 604 and/or the other amount provided 608 stored in the player-winnings database 600.

At 804, the game controller 400 determines an amount won by the player, during the game period, based on the player's performance in one or more games of skill. For example, the game controller 400 may determine that the player has won $80 by playing various games of skill during the week. The game controller 400 then arranges at 806 to provide to the player payment of the amount that he or she has won. The game controller 400 may also update the amount won 512 stored in the player database 500 along with, according to one embodiment, the trivia amount won 606 and/or the other amount won 610 stored in the player-winnings database 600.

The game controller 400 determines a net winning amount associated with the player at 808. For example, the game controller 400 may reduce the amount the player has won during the game period by the amount the player has provided during the game period to calculate the net winning amount.

At 810, the game controller compares the net winning amount with a threshold amount. The threshold amount may be determined, for example, based on a rule stored in the winning limit rule database 700. If the net winning amount is not more than the threshold amount at 810, the game controller 400 permits the player to win an additional amount at 812. For example, the game controller 400 may set the limit status 514 stored in the player database 500 to “not limited.” If the net winning amount is more than the threshold amount at 810, the game controller 400 prevents the player from winning an additional amount at 814. For example, the game controller 400 may set the limit status 514 stored in the player database 500 to “limited.”

FIG. 9 is a flow chart of a method of limiting an amount won by a player that may be performed by the game controller 400. At 902, a winning amount associated with the player is determined. For example, the game controller 400 may retrieve the amount won 512 from the player database 500. According to one embodiment, the winning amount determined at 902 is further based on an amount that has been provided by the player in exchange for game play (e.g., the amount won 512 may be reduced by the amount provided 510).

The game controller 400 determines a winning limit rule at 904. For example, the game controller 400 may evaluate one or more conditions 704 stored in the winning limit rule database 700 to determine a winning limit rule. According to one embodiment, the winning limit rule is associated with an amount won by the player. For example, the winning limit rule may indicate that a player who has won $500 during a single week will be prevented from winning any additional amounts for thirty days. According to other embodiments, the winning limit rule may be associated with, for example, one or more game results, information associated with the player (e.g., the player's average scores over the last thirty days), information associated with a game of skill (e.g., an average amount won by players who play a particular game), and/or a game category.

Based on the winning amount and the winning limit rule, the game controller 400 prevents the player from winning at least one additional amount at 906. For example, the game controller 400 may remove all trivia games from a list of available games displayed via a player device 300.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although most of the embodiments described herein are associated with a game controller 400 limiting an amount that can be won by a player, such a function may instead be performed by a player device 300 or a payment device 110. For example, a player device 300 may determine whether or not a threshold net winning amount has been exceeded (e.g., even while the player is playing a game). Moreover, some embodiments of the present invention may be applicable to players who do not provide payments (e.g., sweepstakes-type prize amounts awarded to a player may be limited).

Although embodiments of the present invention are described with respect to a winning limit associated a single player, according to other embodiments a winning limit is instead associated with multiple players. For example, a set of players (e.g., members of a family or a “team” of players) may be associated with any of the winning limits described herein.

According to one embodiment, a player who participates in multi-player tournaments is prevented from winning an additional amount. For example, a player who wins first place in three tournaments during a month may be prevented from winning an additional amount (e.g., until the next month).

In some of the embodiments described herein, a check may be mailed to a player based on an amount won during game play. However, payments can also be provided to the player in other ways. For example, a game provider may give a player a payment card that the player uses to collect winning amounts via, for example, an Automated Teller Machine (ATM) device.

As described herein, a player may be prevented from winning additional amounts for a period (e.g., a predetermined period or an indefinite period). Note that the length or duration of this period may be based on any of the information described herein, including, for example, the player's past performance or the performance of other players (e.g., an overall amount being won by players via the game system 100).

Embodiments of the present invention have been described with respect to limiting an amount won by a player. Similar systems and methods may be used instead to limit an amount provided by a player in exchange for game play. For example, a “net provided amount” associated with a player may be determined based on (i) an amount provided by the player in exchange for game play and (ii) an amount won by the player based on the player's performance (e.g., the amount provided may be reduced by the amount won to determine the net provided amount). Based on the net provided amount, the game controller 400 may prevent the player from providing at least one additional amount. For example, the game controller 400 may prevent the player from purchasing additional game play for thirty days. Similarly, the game controller 400 may evaluate a providing limit rule and/or prevent the player from providing an additional amount for an indefinite period.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of limiting an amount won by a player, comprising:
determining a net winning amount associated with the player based on (i) an amount provided by the player in exchange for game play and (ii) an amount won by the player based on the player's performance in a game of skill; and
based on the net winning amount, preventing the player from winning at least one additional amount.

2. The method of claim 1, wherein said preventing comprises preventing the player from being able to win a first additional amount while allowing the player to win a second additional amount.

3. The method of claim 1, wherein said preventing comprises preventing the player from playing at least one game of skill.

4. The method of claim 3, wherein each game of skill is associated with at least one game category, and said preventing comprises preventing the player from playing a game of skill associated with a particular game category.

5. The method of claim 1, wherein said preventing comprises preventing the player from winning at least one additional amount for a predetermined period.

6. The method of claim 5, wherein the predetermined period is based on at least one of: (i) the net winning amount, (ii) the amount provided by the player, (iii) the amount won by the player, (iv) a game result, (v) information associated with a game, and (vi) information associated with the player.

7. The method of claim 1, wherein said preventing comprises preventing the player from winning at least one additional amount for an indefinite period.

8. The method of claim 7, wherein said preventing comprises preventing the player from winning at least one additional amount pending certification of a game result.

9. The method of claim 1, wherein a game period is associated with at least one of: (i) the net winning amount, (ii) the amount provided by the player, and (iii) the amount won by the player.

10. The method of claim 9, wherein the game period comprises at least one of: (i) a date, (ii) a period of time, (iii) a duration of game play, (iv) a number of game plays, (v) a number of game results, and (vi) the amount provided by the player.

11. The method of claim 1, wherein the amount won by the player comprises one of: (i) a single prize amount, and (ii) a plurality of prize amounts.

12. The method of claim 1, wherein the amount won by the player is based on one of: (i) a single game result, and (ii) a plurality of game results.

13. The method of claim 1, further comprising:
determining the amount provided by the player.

14. The method of claim 1, further comprising:
determining the amount won by the player.

15. The method of claim 14, further comprising:
determining a game result based on the player's performance in a game of skill,
wherein the amount won by the player is based on the game result.

16. The method of claim 1, further comprising:
arranging for information associated with at least one of the following to be displayed to the player: (i) the net winning amount, (ii) a total amount provided by the player, (iii) a total amount won by the player, (iv) an amount provided by the player during a game period, (v) an amount won by the player during a game period, (vi) a period of time during which the player will be prevented from winning at least one additional amount, and (vii) an additional amount the player will be prevented from winning.

17. The method of claim 1, further comprising:
determining a winning limit rule,
wherein said preventing is further based on the winning limit rule.

18. The method of claim 17, wherein the winning limit rule is associated with at least one of: (i) the net winning amount, (ii) the amount provided by the player, (iii) the amount won by the player, (iv) a game result, (v) information associated with a game, and (vi) information associated with the player.

19. The method of claim 1, wherein the net winning amount is associated with at least one of: (i) a player identifier, (ii) a player device, and (iii) a payment identifier.

20. The method of claim 1, further comprising:
arranging via a payment identifier to receive payment of the amount provided by the player.

21. The method of claim 20, wherein the payment identifier is associated with at least one of: (i) a credit card account, (ii) a debit card account, (iii) a bank account, and (iv) a digital payment protocol.

22. The method of claim 1, further comprising:
arranging to provide to the player payment of the amount won by the player.

23. The method of claim 1, wherein the game of skill comprises one of: (i) a trivia game, (ii) a game associated with a physics simulation, (iii) a puzzle game, and (iv) an arcade-style game.

24. The method of claim 23, wherein the player plays the game of skill at a remote player device in communication with a game controller, and further comprising:
exchanging information with the remote player device via a communication network.

25. The method of claim 24, wherein the remote player device comprises at least one of: (i) a personal computer, (ii) a portable computing device, (iii) a personal digital assistant, (iv) a telephone, (v) a wireless telephone, (vi) a game terminal, (vii) an interactive television device, and (viii) a kiosk.

26. The method of claim 24, wherein the communication network comprises at least one of: (i) the Internet, (ii) a public network, (iii) a public switched telephone network, (iv) a proprietary network, (v) a cable television network, (vi) a wireless network, and (vii) a local area network.

27. A game apparatus, comprising:
a processor; and
a storage device in communication with said processor and storing instructions adapted to be executed by said processor to:
determine a net winning amount associated with a player based on (i) an amount provided by the player in exchange for game play and (ii) an amount won by the player based on the player's performance in a game of skill; and
based on the net winning amount, prevent the player from winning at least one additional amount.

28. The game apparatus of claim 27, wherein said storage device further stores at least one of: (i) a player database, (ii) a player-winnings database, and (iii) a winning limit rule database.

29. The game apparatus of claim 27, further comprising:
a communication device coupled to said processor and adapted to communicate with at least one of: (i) a player device, (ii) a game controller, and (iii) a payment device.

30. A medium storing instructions adapted to be executed by a processor to perform a method of limiting an amount won by a player, said method comprising:
determining a net winning amount associated with the player based on (i) an amount provided by the player in exchange for game play and (ii) an amount won by the player based on the player's performance in a game of skill; and
based on the net winning amount, preventing the player from winning at least one additional amount.

31. A computer-implemented method of limiting an amount won by a player based on the player's performance in at least one game of skill played via a communication network, comprising:
arranging via a payment identifier to receive from the player payment of an amount in exchange for game play during a game period;
determining an amount won by the player during the game period based on the player's performance in at least one game of skill;
arranging to provide to the player payment of the amount won by the player;
determining a net winning amount associated with the player based on (i) the amount provided by the player and (ii) the amount won by the player;
determining a threshold winning amount; and
based on the net winning amount and the threshold winning amount, preventing the player from winning at least one additional amount.

32. A method of limiting an amount won by a player based on the player's performance in at least one game of skill, comprising:
determining a winning amount associated with the player; and
based on the winning amount, preventing the player from winning at least one additional amount for an indefinite period.

33. The method of claim 32, wherein said preventing is further based on an amount provided by the player in exchange for game play.

34. A method of limiting an amount won by a player based on the player's performance in at least one game of skill, comprising:
determining a winning amount associated with the player;
determining a winning limit rule; and
based on the winning amount and the winning limit rule, preventing the player from winning at least one additional amount.

35. The method of claim 34, wherein the winning limit rule is associated with the amount won by the player.

36. The method of claim 34, wherein the winning limit rule is associated with one of: (i) a single game result, and (ii) a plurality of game results.

37. The method of claim 34, wherein the winning limit rule is based on information associated with the player.

38. The method of claim 34, wherein the winning limit rule is based on information associated with a game of skill.

39. The method of claim 34, wherein each game of skill is associated with a game category, and the winning limit rule is based on a game category.

40. The method of claim 34, wherein said preventing is further based on an amount provided by the player in exchange for game play.

41. A method of limiting an amount provided by a player, comprising:
determining a net provided amount associated with the player based on (i) an amount provided by the player in ex change for game play and (ii) an amount won by the player based on the player's performance in a game of skill; and
based on the net provided amount, preventing the player from providing at least one additional amount.

42. A method of limiting an amount provided by a player in exchange for game play, comprising:
determining an amount provided by the player; and
based on the amount provided by the player, preventing the player from providing at least one additional amount for an indefinite period.

43. A method of limiting an amount provided by a player in exchange for game play, comprising:
determining an amount provided by the player;
determining a providing limit rule; and
based on the amount provided and the providing limit rule, preventing the player from providing at least one additional amount.
